(19) United States
(12) Patent Application Publication
(10) Pub. No.: US 2006/0262230 A1
(43) Pub. Date: Nov. 23, 2006

(54) Receiver if system having image rejection mixer and band-pass filter

(75) Inventors: Manabu Ookubo, Shiga (JP); Akio Yokoyama, Osaka (JP); Masayuki Ozasa, Kyoto (JP); Takao Soramoto, Kyoto (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi (JP)

(21) Appl. No.: 11/431,324

(22) Filed: May 10, 2006

(30) Foreign Application Priority Data
May 17, 2005 (JP) JP2005-144415

(51) Int. Cl. H04N 5/50

(52) U.S. Cl. 348/731

(57) ABSTRACT

The receiver IF system or the signal selection device of the present invention includes: frequency converters that obtain polyphase intermediate-frequency signals for suppressing an image component of an RF signal from an input signal; a polyphase filter for removing an image component from the polyphase intermediate-frequency signals; and a band-pass filter composed of an N-pass filter for selecting a channel of an intermediate-frequency signal that is obtained by removing an image component from an output of the polyphase filter. An image rejection filter and a channel selection filter can be integrated at low cost with higher performance, and an area of a substrate for reception can be reduced.

### BACKGROUND OF THE INVENTION

1. Field of the Invention

The present invention relates to a receiver IF system in which a channel selection filter for converting an input RF signal such as a radio receiver into an intermediate-frequency signal is integrated with an image rejection filter.

2. Description of Related Art

FIG. 5 shows an example of a configuration of a superheterodyne receiver IF circuit, which is used in a conventional radio receiver. An RF filter 40 removes an undesired signal including an image signal from an input RF signal, and transmits a desired signal. The RF signal that has passed through the RF filter 40 is amplified by a variable gain RF amplifier 41 and mixed with a local signal from an oscillator 43 by a frequency mixer 42, thereby being converted into an IF frequency. Then, a band-pass filter 44 removes an undesired signal after the mixing from the output of the frequency mixer 42, and transmits only a desired intermediate-frequency signal. The band-pass filter 44 is composed mainly of an external passive component such as a ceramic filter. The output of the band-pass filter 44 passes through an IF amplifier (intermediate-frequency amplifier) 45, and subsequently is converted into a baseband signal by an detector 46. The AGC circuit (automatic gain control circuit) 47 detects an amplitude of the signal after the detection, and supplies a gain control voltage to the variable gain RF amplifier 41 and the IF amplifier 45, for maintaining the amplitude of the baseband signal to be constant. This means that, at the same time, the AGC circuit 47 controls the gains of the variable gain RF amplifier 41 and the IF amplifier 45, as a control function for keeping an appropriate dynamic range for the amplifiers and the filters. A region 48 enclosed with a broken line except the RF filter 40 and the band-pass filter 44 represents an integrated block.

Next, image interference, which is a problem of the heterodyne system, will be described. FIGS. 6A and 6B are conceptual diagrams of the image interference. As shown in FIG. 6A, in the case where a desired wave V_{DF} that is higher than a local frequency by an IF frequency and an image wave V_{IM} that is lower than the local frequency by the IF frequency are input into the frequency mixer 42 at the same time, when they have passed through the band-pass filter 44, a signal represented by V_{OUT} is obtained. In a mixer circuit that is used for a receiver system, where a frequency of a local signal is represented by f_{LO} and the IF frequency is represented by f_{IF}, as shown in FIG. 6B, when either the desired wave V_{DF} has a frequency of (f_{LO}+f_{IF}) that is higher than the local frequency by the IF frequency or the image wave V_{IM} has a frequency of (f_{LO}−f_{IF}) that is lower than the local frequency by the intermediate frequency, they are down-converted by the frequency mixer 42, and the signals V_{OUT} after passing through the band-pass filter 44 are converted into the same intermediate frequency f_{IF}. Thereby, the interference occurs due to the image signal, thus degrading the reception quality.

In order to solve this problem, it is general that, in the circuit shown in FIG. 5, the image signal is removed from the input RF signal by the RF filter 40. However, an external filter increases the cost, and makes it difficult to improve the packaging density of a substrate. Therefore, in recent years, an image rejection mixer for removing the image signal with a circuit technology has been introduced for solving the problem of the image interference. See, for example, JP 2001-513275 A, JP 2003-298356 A, and Sharzad Tadjpour and three others, “A 900-MHz Dual-Conversion Low-IF GSM Receiver in 0.35-μm CMOS” ISSCC, Vol. 36, No. 12, December, 2001. By using this image rejection mixer, the use of the external image rejection filter can be omitted. FIG. 7 shows an example of a configuration of the image rejection mixer.

In FIG. 7, as an RF input, a desired wave of A_{DF}cos(ω_{DF}t) and an image interference wave of A_{IM}cos(ω_{IM}t) are input. As local signals, sin(ω_{LO}t) is supplied to a frequency mixer 50a and cos(ω_{LO}t) is supplied to a frequency mixer 50b, from an oscillator 49.

A high-frequency component in an output signal of the frequency mixer 50a is removed when passing through a LPF (low-pass filter) 51a, and thus an output signal of a LPF 51a is expressed by Formula (1).
(A_{DF}/2)·sin(ω_{LO}t−ω_{DF}t)+(A_{IM}/2)·sin(ωLOt−ω_{IM}t) (1)

A signal that has passed through a 90-degree phase shifter 52 is expressed by Formula (2).
(A_{DF}/2)·cos(ω_{DF}t−ω_{LO}t)+(A_{IM}/2)·cos(ωLOt−ω_{IM}t) (2)

Similarly, a signal that has been output from the frequency mixer 50b and has passed through a LPF 51b is expressed by Formula (3).
(A_{RF}/2)·cos(ω_{DF}t−ω_{LO}t)+(A_{IM}/2)·cos(ωLOt−ω_{IM}t) (3)

Therefore, an output of an adder 53 is A_{DF}cos(ω_{DF}t−ω_{LO}t), and as a result, the image signal of A_{IM}cos(ω_{LO}t−ω_{IM}t) is removed.

As the 90-degree phase shifter 52, a CR-RC circuit that utilizes a 90-degree difference in phase between a voltage at both ends of a capacitor and a voltage at both ends of a resistor may be used. However, there was a problem that, since a bandwidth of the 90-degree phase shifter 52 is narrow, the image rejection characteristics are degraded due to the effects of variations in element property of the capacitor and the resistor, and amplitudes or phase errors of two signals with a 90-degree phase difference. Therefore, a polyphase filter has been tried to be used instead of the 90-degree phase shifter. See, for example, the above-mentioned JP 2003-298356 A and Sharzad Tadjpour and three others, “A 900-MHz Dual-Conversion Low-IF GSM Receiver in 0.35-μm CMOS” ISSCC, Vol. 36, No. 12, December, 2001.

FIG. 8 shows an example of a configuration of a passive polyphase filter. In FIG. 8, each of F1, F2, . . . , Fn is a polyphase filter for four phases. The polyphase filter F1 includes resistors R11 to R14 and capacitors C11 to C14, the polyphase filter F2 includes resistors R21 to R24 and capacitors C21 to C24, and the polyphase filter Fn includes resistors Rn1 to Rn4 and capacitors Cn1 to Cn4, which are connected in n stages. FIG. 9 shows an example of the image rejection characteristics. Herein, a line A represents the characteristics when a desired signal is input, and a line B represents the characteristics when an image signal is input. A difference between the characteristics of the lines A and B represents the image rejection. By connecting the polyphase filters in multiple stages, the bandwidth can be broader, and even if characteristics of elements vary, the degradation of the image rejection characteristics can be suppressed.

Whereas, in order to reduce the cost, there has been an attempt to replace the passive components with the active components (see, for example, JP 2001-513275 A). FIG. 10 shows an example of such a receiver IF circuit. Elements identical to those in FIG. 5 are assigned identical reference numerals for explanation.

In the circuit in FIG. 10, the band-pass filter 54 is composed of a switched capacitor filter, which is used for replacing the passive filter. The RF filter 40 removes an undesired signal including the image signal from the input RF signal, and transmits a desired signal. The RF signal that has passed through the RF filter 40 is amplified by a variable gain RF amplifier 41 and is mixed with a local signal from an oscillator 43 in a frequency mixer 42, thereby being converted into an IF frequency. An output signal of the frequency mixer 42 passes through an anti-aliasing filter 55. Then, the band-pass filter 54 removes an undesired signal after the mixing from the output signal of the frequency mixer 42, and transmits only a desired intermediate-frequency signal. A frequency divider 56 divides the output of the oscillator 43, and supplies a clock having a desired frequency to the switched capacitor filter that composes the band-pass filter 54. An output of the band-pass filter 54 is transmitted to a smoothing filter 57 for removing the clock signal and its harmonic. An output of the smoothing filter 57 passes through the IF amplifier 45, and subsequently is converted into a baseband signal by an IF detector 46. The automatic gain control circuit 47 detects an amplitude of the signal after the detection, and supplies a gain control voltage to the variable gain RF amplifier 41 and the IF amplifier 45 so as to maintain the amplitude of the baseband signal to be constant, thereby performing the gain control so as to keep an appropriate dynamic range for the amplifiers and the filters.

Conventionally, radio receivers are adapted for broad input signal bands, and signals with different modulation types such as AM and FM are input thereto. Therefore, the radio receiver requires not only a channel filter for amplifying only a desired signal in various frequency bands, but also an image signal rejection filter for the heterodyne system. Thus, since many receiving channel filters should be used, and the large number of passive filters are needed, it is difficult to reduce the cost and the packaging area.

Although the passive components may be replaced with the active components as disclosed in JP 2001-513275 A, many active filters are needed for each of the input signal bands or the types of signals. This may lead to an increase in circuit current, chip area, or noise.

In the conventional example shown in FIGS. 5 and 10, the RF filter 40 has both functions of the image rejection filter and the channel filter. The band-pass filters 44, 54 have only a function of removing an undesired signal after the mixing, and a function of selecting a desired IF signal.

Since filters having high selecting characteristics and image rejecting functions are required, in the configuration shown in FIG. 5, each of these filters is composed mainly of a ceramic filter, a SAW filter or the like. In the case where these filters are integrated into an active circuit, they are required to ensure higher precision, and thus it is difficult for them to obtain the stable filter characteristics against the variations in element property.

In the case of composing the band-pass filter 54 having high selectivity with the switched capacitor filter in the configuration shown in FIG. 10, since a capacitor ratio of the switched capacitor increases significantly, the switched capacitor becomes sensitive to the effects of the variations in element property, the gains of the operational amplifier and the parasitic capacitor, thus making it very difficult to compose the band-pass filter 54.

### SUMMARY OF THE INVENTION

The present invention intends to solve the above-mentioned conventional problems so as to provide a receiver IF system that is suitable for integrating passive components, which are an image rejection filter and a channel selection filter, for reducing the cost of a receiver and the area of a circuit substrate for reception, and can achieve high-performance integration at low cost, and to provide a signal selection device.

In order to attain the above-mentioned object, the receiver IF system or the signal selection device of the present invention includes: a frequency converter that obtains a polyphase intermediate-frequency signal for suppressing an image component of an RF signal from an input signal; a polyphase filter for removing an image component from the polyphase intermediate-frequency signal; and a band-pass filter composed of an N-pass filter for selecting a channel of an intermediate-frequency signal that is obtained by removing an image component from an output of the polyphase filter.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing a receiver IF circuit using a receiver IF system of the embodiment of the present invention.

FIG. 2 is a block diagram showing a receiver IF circuit in which an automatic gain control function is added to the receiver IF circuit of FIG. 1.

FIG. 3A is a view showing an example of an N-pass filter that is used in the receiver IF circuit of FIG. 1.

FIG. 3B is a view showing an example of a dock timing of the N-pass filter of FIG. 3A.

FIG. 3C is a view showing frequency characteristics (1) of the N-pass filter of FIG. 3A.

FIG. 3D is a view showing frequency characteristics (2) of the N-pass filter of FIG. 3A.

FIG. 4 is a circuit diagram showing an example of a switched capacitor filter (SCF) composing the N-pass filter of FIG. 3A.

FIG. 5 is a block diagram showing a receiver IF circuit of a conventional example.

FIG. 6A is a view showing a phenomenon of interference by an image signal.

FIG. 6B is a view showing the phenomenon of the interference by the image signal.

FIG. 7 is a block diagram showing a configuration of an image rejection mixer of the conventional example.

FIG. 8 is a circuit diagram showing an example of a passive polyphase filter.

FIG. 9 is a view showing image rejection characteristics of the passive polyphase filter.

FIG. 10 is a block diagram showing a receiver IF circuit having a configuration where an IF filter of the conventional example is composed of a switched capacitor circuit.

### DETAILED DESCRIPTION OF THE INVENTION

According to the present invention, by using a polyphase filter for image rejection and using an N-pass filter for a band-pass filter, a function of a conventional external component can be taken into an inside of an IC, thereby improving the packaging density on a substrate, and at the same time, reducing the electric power and the cost. Moreover, by using a clock and a switch, plural filters having different filter characteristics can be realized with a single basic filter. Thereby, a chip area can be reduced significantly.

The receiver IF system or the signal selection device of the present invention preferably includes a variable gain amplifier that amplifies an input signal and supplies the amplified signal to the frequency converter; and an automatic gain control circuit that controls a gain of the variable gain amplifier in accordance with a signal level output from the band-pass filter.

Moreover, it is preferable that the band-pass filter corresponds to an input frequency band, and a frequency response can be changed in accordance with a reference signal.

It is preferable that the N-pass filter is composed of a discrete-time system. And, it is preferable that the clock frequency of the discrete-time system is higher than an input RF signal band.

The embodiment of the present invention will be described hereinafter, with reference to drawings.

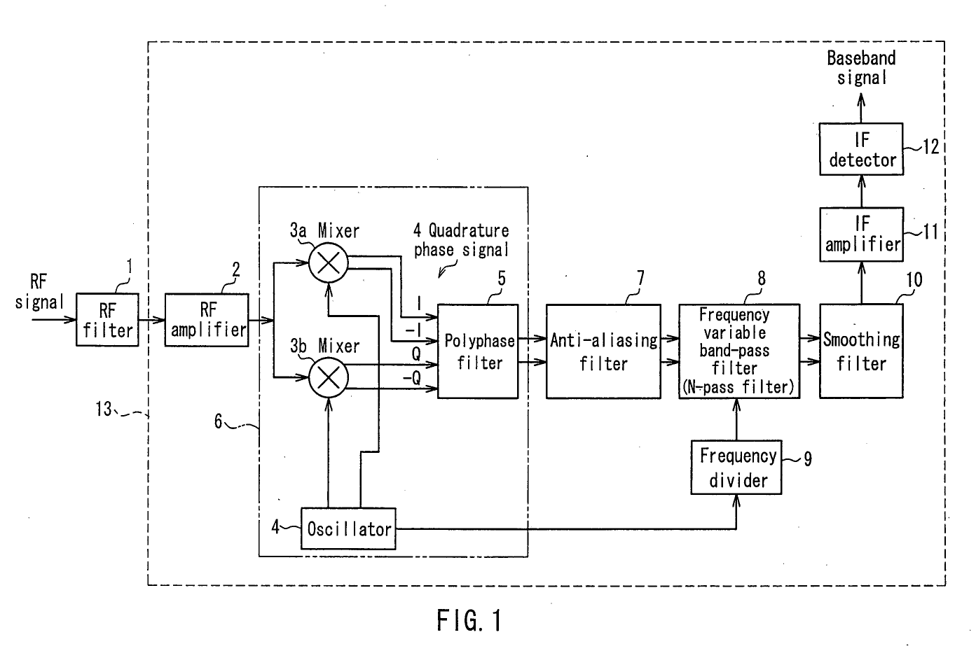

FIG. 1 is a block diagram showing the basic configuration of a receiver IF circuit based on a receiver IF system of the embodiment of the present invention. In FIG. 1, an RF filter 1 selects a frequency of the input RF signal, the input RF signal is amplified by an RF amplifier 2, and the thus amplified signal subsequently is supplied to frequency mixers 3a and 3b, respectively. The signal input into the frequency mixers 3a and 3b is mixed with each of local signals from an oscillator 4 that are orthogonal to each other to be converted into quadrature phase signals I, −I, Q and −Q signals, which are supplied to a polyphase filter 5. The image rejection mixer 6 is composed of the frequency mixers 3a, 3b, the oscillator 4 and the polyphase filter 5. An output of the polyphase filter 5 passes through an anti-aliasing filter 7, and subsequently is supplied to a frequency variable band-pass filter 8 to select only a desired IF signal. The frequency variable band-pass filter 8 is composed of the N-pass filter, and is controlled based on a reference signal (clock signal) obtained by dividing an output of the oscillator 4 with a frequency divider 9, thus selecting and adjusting the frequency. An output of the frequency variable band-pass filter 8 passes through a smoothing filter 10 for removing the clock signal and its harmonic, is subsequently amplified by an IF amplifier 11, and further is converted into a baseband signal by an IF detector 12. A region 13 enclosed with a broken line represents an integrated block.

According to this configuration, by varying a dividing ratio of the frequency divider 9, the frequency of the reference signal can be varied, and thus frequency selection characteristics of the frequency variable band-pass filter 8 can be changed.

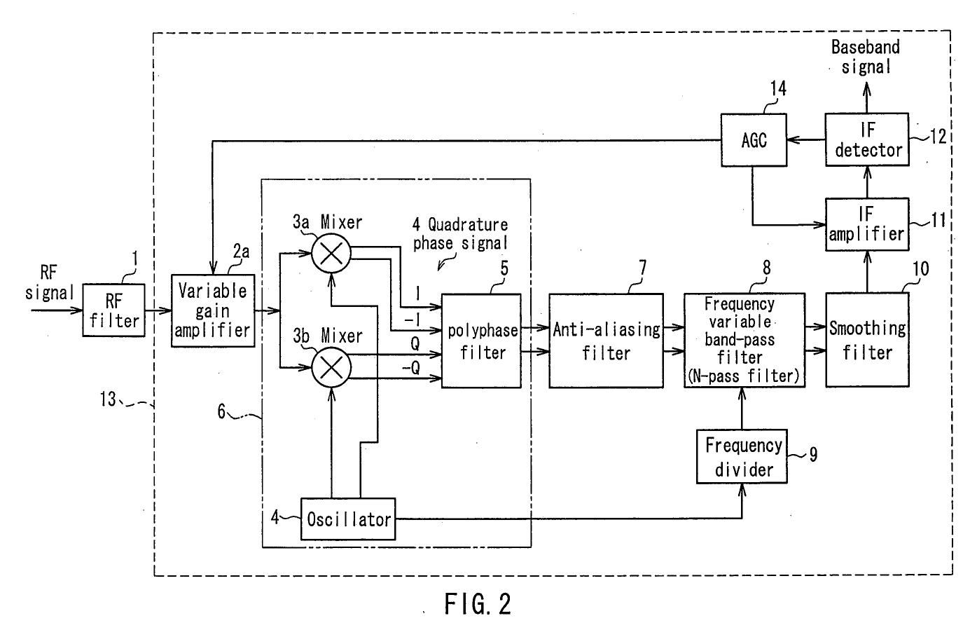

In addition, the receiver IF circuit with the above-described configuration also may have a configuration that can perform automatic gain control as shown in FIG. 2. The receiver IF circuit of FIG. 2 has a configuration where the RF amplifier 2 of FIG. 1 is replaced with a variable gain RF amplifier 2a, and an AGC circuit 14 is added. An output of the IF detector 12 is applied to the AGC circuit 14, and the AGC circuit 14 supplies a control voltage to the variable gain RF amplifier 2a and the IF amplifier 11 so as to maintain the signal level to be constant, thereby controlling the gain.

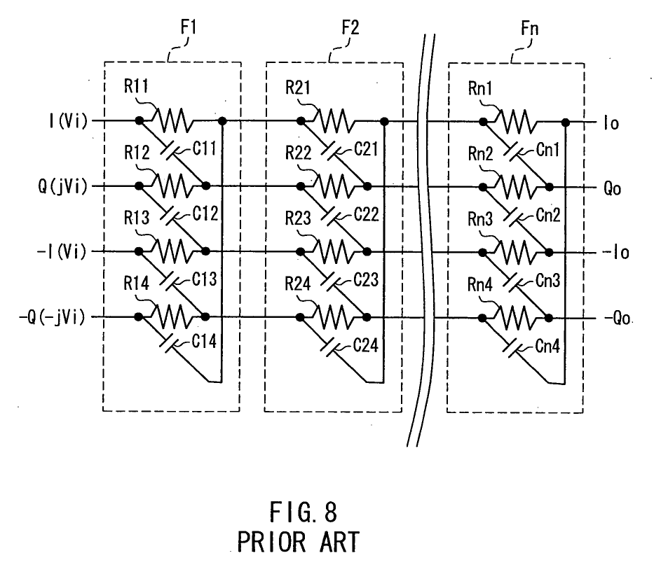

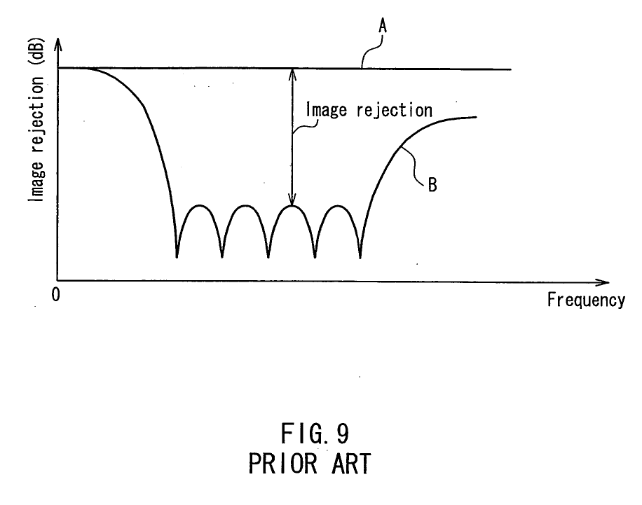

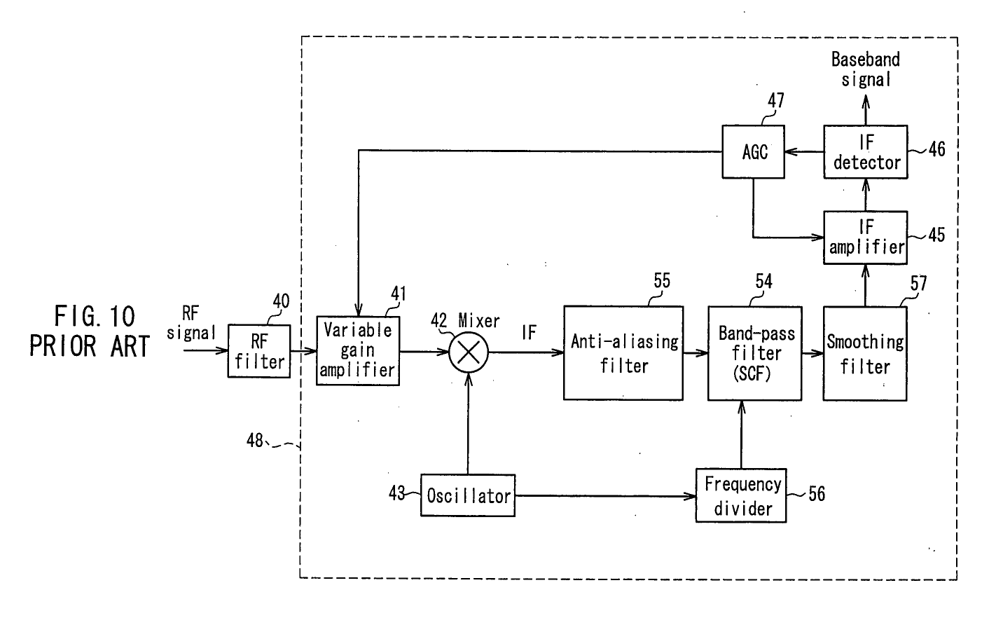

The polyphase filter 5 may be composed of the passive polyphase filter shown in FIG. 8. The quadrature phase signals I, −I, Q and −Q enter with the same amplitude for input. The polyphase filters F1, F2, . . . and Fn respectively have center frequencies of f01=1/(2πR11·C11), f02=1/(2πR21·C21), . . . and f0n=1/(2πRn1·Cn1), and exhibit notch characteristics B for the image signal as shown in FIG. 9 and frequency characteristics shown by substantially all-pass characteristics A for a desired signal. A difference between the characteristics A and B is image rejection. Since the polyphase filters are connected in multiple stages, even if CR variations exist, desired image rejection characteristics can be achieved.

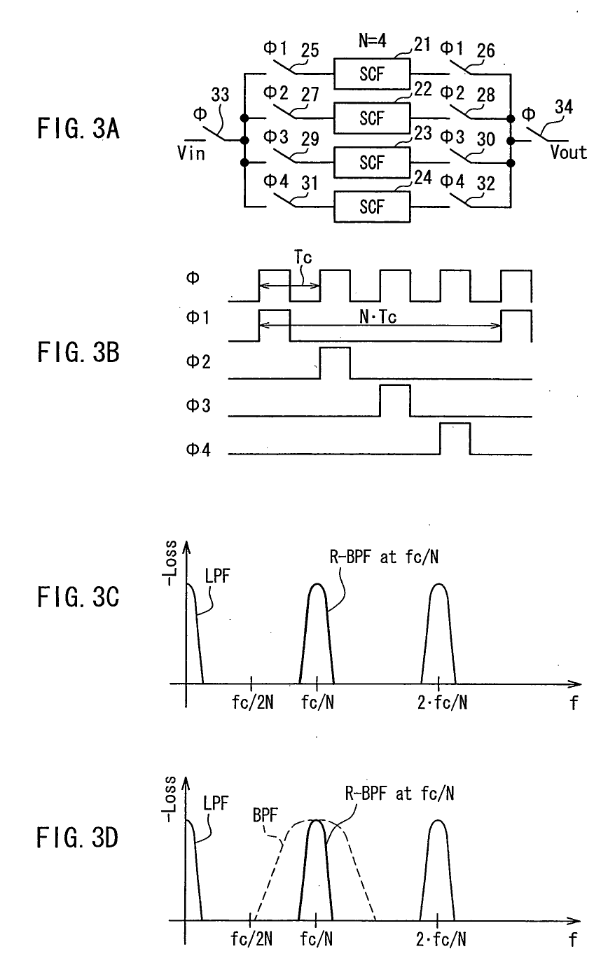

The N-pass filter composing the frequency variable band-pass filter 8 can have a configuration using, for example, a switched capacitor filter (SCF). FIG. 3A shows an example of a basic configuration of the N-pass filter (in the case of N=4) using the SCF. The SCFs 21 to 24 respectively are connected in parallel via switches 25 to 32, and a signal is input via a switch 33 and is output via a switch 34. FIG. 3B shows timings of clocks φ and φ1 to φ4 that are supplied to the respective switches. The clocks φ and φ1 to φ4 correspond to the reference numerals that are assigned to the switches in FIG. 3A, respectively.

Mechanisms of the N-pass filter (NPF) will be described below. Here, when respective transfer functions Hp(z) of the SCFs of N passes are assumed to be the same, Hp(z) is represented as follows:

$$\begin{matrix}Hp ( z ) = V 1 out ( z ) / V 1 in ( z ) \\ = V 2 out ( z ) / V 2 in ( z ) \\ = …\end{matrix}$$

Thus, a whole of the transfer function H(z) is represented as follows:

$$\begin{matrix}H ( z ) = Vout ( z ) / Vin ( z ) \\ = \{ V 1 out ( z ) + V 2 out ( z ) + ⋯ \} / \{ V 1 in ( z ) + V 2 in ( z ) + ⋯ \} \\ = \{ Hp ( z ) \cdot V 1 in ( z ) + Hp ( z ) \cdot V 2 in ( z ) + ⋯ \} / \{ V 1 in ( z ) + V 2 in ( z ) + ⋯ \} \\ = Hp ( z )\end{matrix}$$

Herein, a sampling rate of each pass is represented by 1/NTc=fc/N, by using a period Tc of the clock φshown in FIG. 3B. Next, the case where the SCF is the LPF will be considered. Since the sampling rate of each pass is fc/N, replicas of the LPF (at f=0) are formed at points of fc/N, 2·fc/N, 3·fc/N, . . . as shown in FIG. 3C, and a replicated band pass filter (R-BPF) is formed at each point. Herein, when considering the case of using only a single pass, it is found that, since an input frequency of the pass with a Nyquist frequency of fc/(2N) or larger is in the state of aliasing, the BPF (at fc/N) is outside a Nyquist range, and thus cannot be used as the BPF. Whereas, when considering the case of using the N passes, since a Nyquist frequency of a whole of the N passes is fc/2, the BPF (at fc/N) is within the Nyquist range, and thus can be used as the BPF.

Moreover, since the R-BPFs (at f=0, 2·fc/N, 3·fc/N, . . . ) remain, desired BPF characteristics can be obtained by removing an undesired input frequency using another BPF, as shown in FIG. 3D (see “ANALOG MOS INTEGRATED CIRCUITS FOR SIGNAL PROCESSING”, Roubik GreGorian and one other, John Wiley & Sons, Inc.).

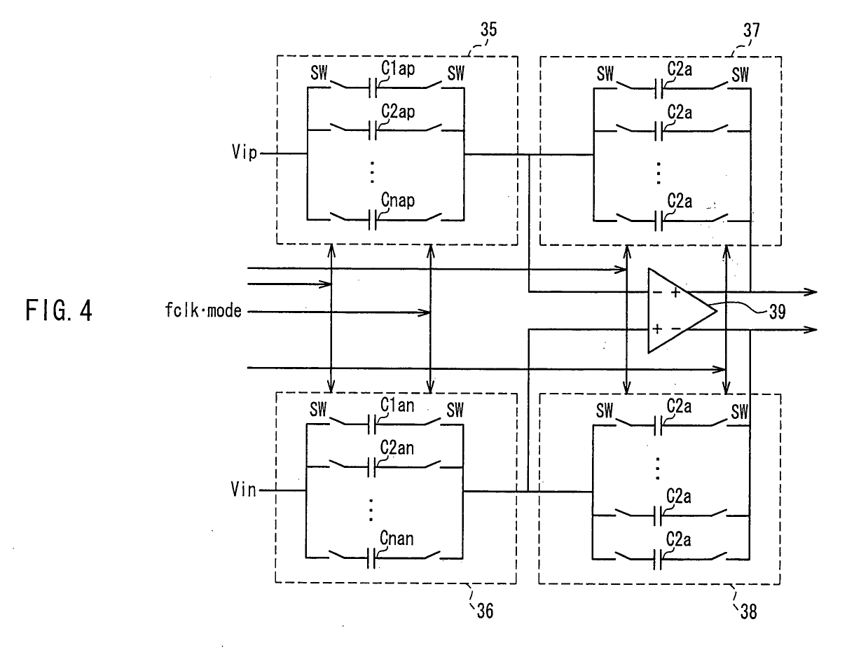

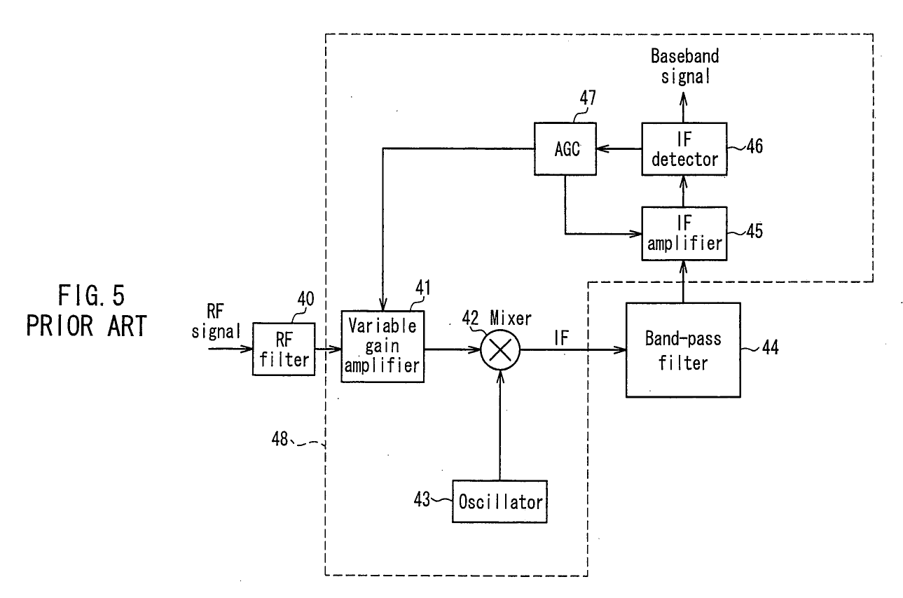

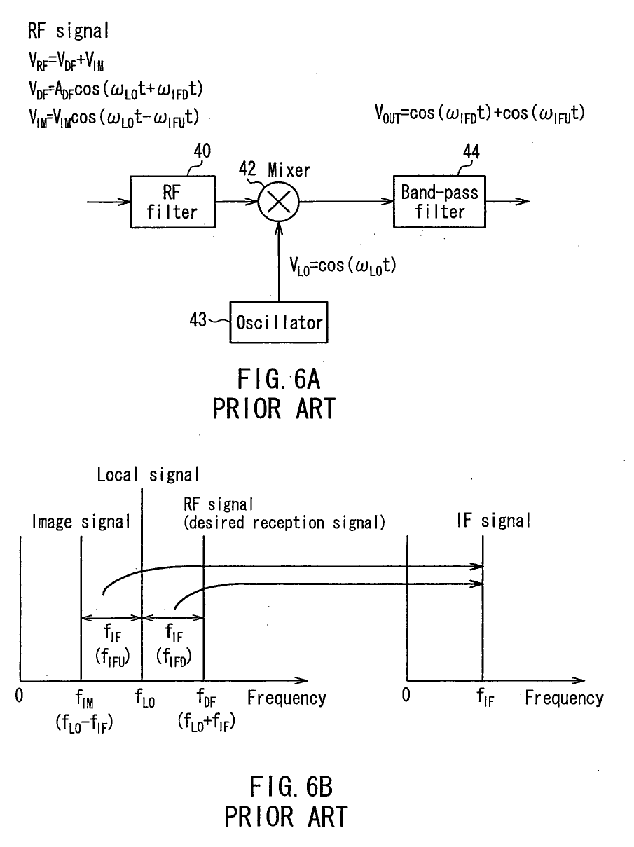

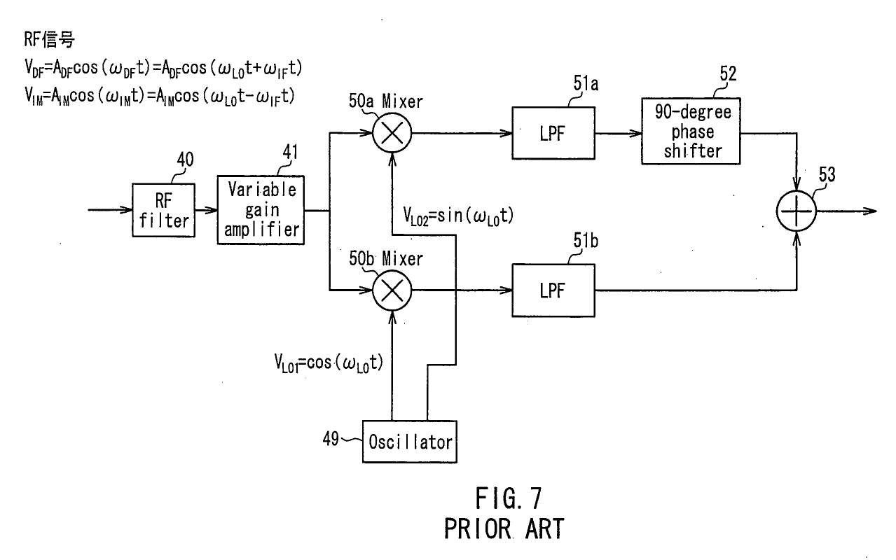

Generally, a BPF is composed by converting a frequency of an LPF. However, rather than when composing the BPF by converting the frequency of the LPF, when composing the BPF by using an N-pass filter, the same BPF characteristics can be achieved with a lower Q value. As a result, since a capacitor ratio of the switched capacitor decreases, the switched capacitor becomes less sensitive to the effects of the variations in element property, the gains of the operational amplifier and the parasitic capacitor, whereby a narrow-band filter can be obtained with higher precision inside the IC.

Whereas, there is a great advantage in composing the N-pass filter of the SCF. The advantage is that frequency characteristics can be changed by varying a clock frequency. FIG. 4 shows an example of a variable selection filter. This variable selection filter is composed of capacitor selection circuit networks 35, 36, 37, 38 and an operational amplifier 39, by which a capacitance is selected at a required frequency selection mode. Moreover, a clock selected at a required frequency is supplied to a switch SW. According to the configuration of FIG. 4, an integrator or a first-order basic filter can be structured, and a filter having desired selection characteristics can be structured by selecting the capacitor selection circuit network and the frequency of the clock. Similarly, a filter of a second order or higher also can be structured. The operational amplifier 39 is used commonly for any filters. Thereby, the electric power and the cost can be reduced.

In addition, the switched capacitor filter is of a discrete-time system, and an output thereof includes many harmonic components of the clock frequency. Therefore, when the switched capacitor filter is integrated with an RF circuit in the same chip, the harmonic components of the clock may affect the small RF input circuit as noise, and also may be undesired components for the frequency mixers. Whereas, if the clock frequency is higher than the frequency of the RF input signal, the harmonic components of the clock are attenuated during transmission over the circuit. At the same time, the effect of the harmonic components as noise on the input signal band can be reduced. Accordingly, it is preferable that, by allowing the clock of the switched capacitor filter composing the N-pass filter to be higher than the frequency of the RF input, the switched capacitor circuit is prevented from being a source to generate a disturbing wave of the RF circuit.

The invention may be embodied in other forms without departing from the spirit or essential characteristics thereof. The embodiment disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A receiver IF system comprising:
a frequency converter that obtains a polyphase intermediate-frequency signal for suppressing an image component of an RF signal from an input signal;
a polyphase filter for removing an image component from the polyphase intermediate-frequency signal; and
a band-pass filter composed of an N-pass filter for selecting a channel of an intermediate-frequency signal that is obtained by removing an image component from an output of the polyphase filter.

2. The receiver IF system according to claim 1, further comprising:
a variable gain amplifier that amplifies an input signal and supplies the amplified signal to the frequency converter; and
an automatic gain control circuit that controls a gain of the variable gain amplifier in accordance with a signal level output from the band-pass filter.

3. The receiver IF system according to claim 1, wherein a frequency response of the band-pass filter is variable so as to correspond to an input frequency band in accordance with a reference signal.

4. The receiver IF system according to claim 1, wherein the N-pass filter is composed of a discrete-time system.

5. The receiver IF system according to claim 1, wherein a clock frequency of the discrete-time system that composes the N-pass filter is higher than an RF signal band.

6. A signal selection device comprising:
a frequency converter that obtains a polyphase intermediate-frequency signal for suppressing an image component of an RF signal from an input signal;
a polyphase filter for removing an image component from the polyphase intermediate-frequency signal; and
a band-pass filter composed of an N-pass filter for selecting a channel of an intermediate-frequency signal that is obtained by removing an image component from an output of the polyphase filter.

7. The signal selection device according to claim 6, further comprising:
a variable gain amplifier that amplifies an input signal and supplies the amplified signal to the frequency converter; and
an automatic gain control circuit that controls a gain of the variable gain amplifier in accordance with a signal level output from the band-pass filter.

8. The signal selection device according to claim 6, wherein a frequency response of the band-pass filter is variable so as to correspond to an input frequency band in accordance with a reference signal.

9. The signal selection device according to claim 6, wherein the N-pass filter is composed of a discrete-time system.

10. The signal selection device according to claim 9, wherein a clock frequency of the discrete-time system that composes the N-pass filter is higher than an RF signal band.
